(19) United States
(12) Patent Application Publication
(10) Pub. No.: US 2022/0040759 A1
(43) Pub. Date: Feb. 10, 2022

(54) PARTICLES FOR JOINING MATERIAL AND PRODUCTION METHOD THEREOF, JOINING PASTE AND PREPARATION METHOD THEREOF, AND PRODUCTION METHOD OF JOINED BODY

(71) Applicant: MITSUBISHI MATERIALS CORPORATION, Tokyo (JP)

(72) Inventors: Tomohiko Yamaguchi, Naka-shi (JP); Kohei Otogawa, Naka-shi (JP); Akihiro Higami, Naka-shi (JP)

(73) Assignee: MITSUBISHI MATERIALS CORPORATION, Tokyo (JP)

(21) Appl. No.: 17/281,344

(22) PCT Filed: Oct. 2, 2019
(86) PCT No.: PCT/JP2019/038945

§ 371 Date: Mar. 30, 2021

(30) Foreign Application Priority Data
Oct. 4, 2018 (JP) 2018-188905
Dec. 27, 2018 (JP) 2018-245662

(51) Int. Cl. B22F 1/02; B22F 7/06; B22F 9/24; H01B 1/22

(52) U.S. Cl. CPC B22F 1/02; B22F 7/064; B22F 2301/10; H01B 1/22; B22F 9/24

(57) ABSTRACT

Particles for joining material are such that an organic protective film is formed on the surface of copper nanoparticles, and have a BET specific surface area in a range of 3.5 m²/g to 8 m²/g, and a BET diameter in a range of 80 nm to 200 nm, wherein the organic protective film is included in a range of 0.5% to 2.0% by mass with respect to the particles for joining material. When the particles for joining material are analyzed by using the Time-Of-Flight Secondary Ion Mass Spectrometry (TOF-SIMS) method, respective detected amounts of C₃H₃O₃⁻ ions and C₃H₄O₂⁻ ions are in a range of 0.05 times to 0.2 times a detected amount of Cu⁺ ions, and a detected amount of ions of C₅ or more is in a range less than 0.005 times the detected amount of Cu⁺ ions.

### TECHNICAL FILED

The present invention relates to particles for joining material used as a raw material of paste for joining at the time of assembling or mounting electronic components, and including an organic protective film formed on the surface of copper nanoparticles, and a method of preparing the same. Moreover, the present invention relates to a paste for joining including such particles for joining material, and a method of preparing the same. Further, the present invention relates to a method of producing a joined body by using such a paste for joining. It is to be noted that the present International Application claims the priority based on the Japanese Patent Application No. 2018-188905, filed on Oct. 4, 2018 (JP Appl. No. 2018-188905), and the Japanese Patent Application No. 2018-245662, filed on Dec. 27, 2018 (JP Appl. No. 2018-245662A), the entire contents of the JP Appl. No. 2018-188905 and JP Appl. No. 2018-245662 being incorporated in the present International Application.

### BACKGROUND ART

In the case of joining two components or more at the time of assembling or mounting electronic components, joining materials are typically used. As such joining materials, there have been known joining materials in the form of paste containing metallic particles dispersed in a solvent. When joining components by using such joining materials, joining material is coated onto the surface of one component, and other component is caused to be in contact with the coated surface to apply heating thereto in this state so that these components can be joined.

Metallic particles as raw material used in such a use purpose are generally required to have higher thermal conductivity and/or higher heat resistance. For this reason, there are many cases where metallic particles consisting of gold or silver, etc. may be used, and there many cases where silver inexpensive than gold may be used thereamong. However, in the case where silver particles are used, there is the problem that migration may be apt to take place at the joints or the wiring portions thus formed.

In connection with suppression of the above-mentioned migration, it is useful to use copper material rather than silver material. Particularly, copper nanoparticles are sintered at a temperature which is relatively lower than that of bulk copper, and a joining layer thus obtained is excellent in the thermal conductivity and the high heat resistance. In addition, there is the problem that its cost is inexpensive as compared to that of the silver material, but the surface of the copper nanoparticles may be easily oxidized resulting from the fact that the specific surface area of the copper nanoparticles is large.

As a method of preventing oxidation of copper nanoparticles, there is disclosed a method of coating, at the time of producing copper nanoparticles, the periphery thereof with silicone oil (see e.g., the Patent document 1 (claim 1)), a method of adding additive agent such as malic acid, citric acid or tartaric acid, etc. at the time of producing fine powder of copper to suppress oxidation (see e.g., the Patent document 2 (claims 1 and 3)), or a method of producing copper nanoparticles containing citric acid on the particle surface (see e.g., the Patent document 3 (claim 1)). In the method of the Patent document 3, the amount of citric acid is caused to be greater than 15% by weight and to be lower than 40% by weight with respect to the weight of copper.

### PRIOR ART DOCUMENT

### Patent Document

Patent Document 1: Japanese Patent Laid Open No. 2005-060779 publication
Patent Document 2: Japanese Patent Laid Open No. 2007-258123 publication
Patent Document 3: Japanese Patent No. 5227828 publication

### SUMMARY OF THE INVENTION

### Problems to be Solved by the Invention

Copper nanoparticles coated with silicone oil disclosed in the Patent document 1 were very excellent in terms of the oxidation resistance, but had the problem that because silicone oil which has not been completely volatized after heat treatment will be left in the joining layer, the joining strength and/or the thermal conductivity may be lowered to much degree owing to unsatisfactory sintering.

In the method disclosed in the Patent document 2, additive agent for suppressing oxidation is later added to the produced copper powder to allow it to be adsorbed by means of ball milling machine, etc. However, since uniform coating is difficult with such a technique, it was difficult to completely prevent oxidation of copper nanoparticles.

In the method disclosed in the Patent document 3, copper nanoparticles containing citric acid on the surface thereof are produced to thereby suppress oxidation. However, there was the problem that the amount of citric acid is very high such that it is greater than 15% by weight and is lower than 40% by weight with respect to the mass of the copper so that gas produced by desorption of the surface protective film at the time of forming a joined body results in voids at joints of the joining film, etc. From the fact described above, there are required copper nanoparticles for joining material which includes a surface protective film to which oxidation resistance has been rendered, which have very small gas component produced when its protective film is desorpted, and which are excellent in the low temperature sinterability.

In addition, in the method disclosed in the Patent document 3, a first aqueous solution and a second aqueous solution which have been respectively adjusted so that the pH is in a range of 10 or more to less than 12 are mixed to produce copper nanoparticles. However, there was the problem that copper ions change to copper (II) hydroxide in the basic solution, leading to the fact that such copper (II) hydroxide is apt to be precipitated so that yield of the target particles may be lowered. From the fact described above, there are being required methods of producing, in a high yield, copper nanoparticles for joining material including a surface protective film to which oxidation resistance has been rendered, and excellent in the low temperature sinterability.

A first object of the present invention is to provide particles for joining material which are excellent in the oxidation resistance during preservation, which are excellent in the low temperature sinterability at the time of joining, and which have less gas component produced when the protective film is desorbed so that the joining strength at the time of joining can be enhanced. A second object of the present invention is to provide a method of producing, in a high yield, particles for joining material, which are excellent in the oxidation resistance during preservation, which are excellent in the low temperature sinterability at the time of joining, and which have a higher joining strength at the time of joining. A third object of the present invention is to provide a paste for joining including such particles for joining material and a method of preparing the same. A fourth object of the present invention is to provide a method of producing a joined body by using such a paste for joining.

### Means for Solving the Problems

A first aspect of the present invention is directed to particles for joining material including an organic protective film formed on the surface of copper nanoparticles,

characterized in that the particles for joining material are such that the BET specific surface area is in a range of 3.5 m²/g to 8 m²/g, and the BET diameter converted from the specific surface area is in a range of 80 nm to 200 nm, and that the organic protective film is included in a range of 0.5% to 2.0% by mass with respect to 100% by mass of the particles for joining material, and that when the particles for joining material are analyzed by using the Time-of-Flight Secondary ion Mass Spectrometry (TOF-SIMS), respective detected amounts of C₃H₃O₃⁻ ions and C₃H₄O₂⁻ ions are in a range of 0.05 times to 0.2 times a detected amount of the Cu⁺ ions, and a detected amount of ions of C₅ or more is in a range less than 0.005 times the detected amount of Cu⁺ ions.

A second aspect of the present invention is the invention based on the first aspect, and is directed to particles for joining material in which when heated for 30 minutes at a temperature of 300° C. under an inert gas atmosphere, the organic protective film is decomposed not less than 50% by mass, and gas thus decomposed is evaporative gas and water vapor of carbon dioxide, nitrogen gas or acetone.

A third aspect of the present invention is directed to a paste for joining including a volatile solvent, and the particles for joining material of the first aspect or the second aspect.

A fourth aspect of the present invention is directed to a method, which comprises: adding a pH adjusting agent into an aqueous dispersion containing copper citrate at a room temperature to make pH adjustment so that the pH is not less than 3 and is less than 7; adding and mixing hydrazine compound into the pH adjusted aqueous dispersion of copper citrate under an inert gas atmosphere; heating the mixed solution thus obtained under the inert gas atmosphere so that the temperature is not less than 60° C. and is not more than 80° C.; and holding the heated mixed solution for a time period which is not less than 1.5 hours and is not more than 2.5 hours to thereby reduce the copper citrate to produce copper nanoparticles thus to produce particles for joining material including an organic protective film formed on the surface of the copper nanoparticles.

A fifth aspect of the present invention is directed to a method, comprising: mixing a volatile solvent and particles for joining material of the first aspect or the second aspect, or particles for joining material which have been produced in accordance with the fourth aspect to prepare a paste for joining.

A sixth aspect of the present invention is directed to a method of producing a joined body, which includes a step of applying or coating, onto the surface of a substrate or an electronic component, the paste for joining of the third aspect or the paste for joining which has been prepared in accordance with the fifth aspect thus to form a coated layer; a step of overlapping the substrate and the electronic component with each other through the coated layer; and a step of heating, at a temperature which is not less than 200° C. and is not more than 300° C., under an inert atmosphere while applying a pressure of 30 MPa or less, the substrate and the electronic component which have been overlapped with each other to sinter the coated layer to thereby form a joining layer thus to join the substrate and the electronic component by the joining layer.

### Effect of the Invention

The particles for joining material according to the first aspect of the present invention is such that because the copper nanoparticles serving as base particles are coated with the organic protective film, they are excellent in the oxidation resistance during preservation. Since the BET specific surface area of the particles for joining material is in a range of 3.5 m²/g to 8 m²/g, and the BET diameter converted from the specific surface area is in a range of 80 nm to 200 nm, the reaction area of the particles for joining material is large, and the reactivity due to heating in joining is high. Thus, the particles for joining material can be sintered at a relatively low temperature. Moreover, since the ratio with respect to 100% by mass of the particles for joining material of the organic protective film is in a range of 0.5% to 2.0% by mass, which is extremely smaller than the ratio which is not less than 15% by mass and is not more than 40% by mass described in the Patent document 3, the amount of gas when the organic protective film is decomposed at the time of baking is small. Thus, the number of voids at joints of the joining film, etc. resulting from decomposition gas is decreased so that the joining strength can be enhanced.

Moreover, when the particles for joining material are analyzed by using the Time-Of-Flight Secondary Ion Mass Spectrometry (TOF-SIMS), respective detected amounts of C₃H₃O₃⁻ ions and C₃H₄O₂⁻ ions are in a range of 0.05 times to 0.2 times a detected amount of the Cu⁺ ions. Therefore, there is no excess or deficiency in the amount of organic protective film in view of protecting copper nanoparticles. For this reason, the organic protective film protects aggregation of particles for joining material therebetween without oxidizing the surface of the copper nanoparticles. In addition, since the detected amount of ions of C₅ or more is in a range less than 0.005 times the detected amount of Cu⁺ ions, there is no possibility that the sintering temperature may be raised without damaging sinterability of particles for joining material.

In the particles for joining material according to the second aspect of the present invention, since when heated for 30 minutes at a temperature of 300° C. under the inert gas atmosphere, the organic protective film is decomposed not less than 50% by mass, residue of the organic protective film within the joining film is small, resulting in no possibility that the joining strength may be lowered. In addition, since gas resulting from decomposition of the organic protective film is vaporized gas and water vapor of carbon dioxide gas, nitrogen gas or acetone, the particles for joining material are advantageously coated with the organic protective film which is of the configuration easy to be desorbed at a relatively low temperature.

Since the paste for joining according to the third aspect of the present invention includes the particles for joining material and volatile solvent, such paste helps to permit the joined body to be sintered at a low temperature, advantageously resulting in no possibility that any migration of the joining material components may take place at joints or wiring portions.

In the method of producing particles for joining material according to the fourth aspect of the present invention, when hydrazine compound as a reducing agent is added and mixed into an acid solution which is not less than pH 3 and is less than pH 7 so that copper nanoparticles are produced in the solution, citric acid produced from copper citrate rapidly covers the surfaces of the copper nanoparticles to thereby suppress dissolution of the copper nanoparticles. Thus, when the copper citrate is reduced, copper ions are difficult to result in copper (II) hydroxide and are difficult to precipitate as the copper (II) hydroxide, thus to have ability to produce the target particles in a higher yield.

Moreover, since copper nanoparticles as base particles thus produced are coated with the organic protective film, they are excellent in oxidation resistance during preservation or storage. Further, since the base particles thus produced are copper nanoparticles, the reaction area of the particles for joining material is large so that reactivity due to heating in joining is high. Thus, it is possible to sinter the particles for joining material at a relatively low temperature.

Further, the produced particles for joining material are such that the amount of gas when the organic protective film is decomposed is small at the time of baking, and the number of voids in the joining film resulting from the decomposition gas is decreased so that the joining strength can be enhanced.

In the method of preparing the paste for joining according to the fifth aspect of the present invention, since the particles for joining material and the volatile solvent are mixed thus to produce a paste, the paste thus produced helps to permit a joined body to be sintered at a low temperature, advantageously resulting in no possibility that any migration of the joining material components may take place at the joints or the wiring portions.

In the method of producing the joined body according to the sixth aspect of the present invention, a substrate and an electronic component are heated at a temperature which is not less than 200° C. and is not more than 300° C. under the inert atmosphere while applying a pressure of 30 MPa or less thereto through the coated layer by using the paste for joining including the particles for joining material. By this method, it is possible to produce, in a high yield, a joined body having a higher joining strength in a manner not to give mechanical damage and thermal damage to the substrate and the electronic component at a relatively lower temperature which is not less than 200° C. and is not more than 300° C.

### BRIEF DESCRIPTION OF THE DRAWINGS

FIG. 1 is a diagram showing, in a model form, the cross sectional structure of particles for joining material according to an embodiment of the present invention.

FIG. 2 is a photo-diagram in which an aggregate of particles for joining material of an example 1 is photographed by means of the microscope.

### BEST MODE(S) FOR CARRYING OUT THE INVENTION

An embodiment for carrying out the present invention will now be described with reference to the attached drawings.

### [Particles for Joining Material]

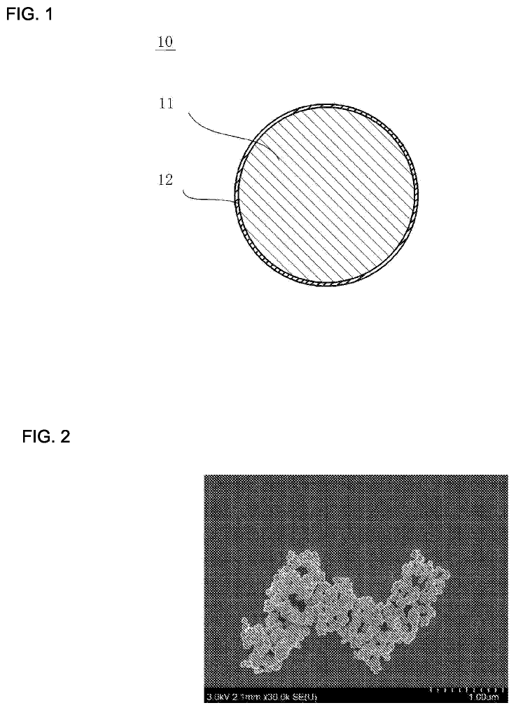

As illustrated in FIG. 1, in particles 10 for joining material of this embodiment, base particles 11 consist of copper nanoparticles, wherein the surface of the base particles 11 is coated with an organic protective film 12.

The particles 10 for joining material are such that the BET specific surface area is in a range of 3.5 m²/g to 8 m²/g, and the BET diameter converted from the specific surface area is in a range of 80 nm to 200 nm. A preferred BET specific surface is in a range of 4.0 m²/g to 8.0 m²/g, and a preferred BET diameter is in a range of 80 nm to 170 nm. When the BET specific surface area is less than 3.5 m²/g, or the BET diameter is above 200 nm, the reaction area of the particles for joining material is not large, and the reactivity due to heating in joining is low. Thus, sintering at a relatively low temperature cannot be performed. Moreover, when the BET specific surface area is above 8 m²/g, or the BET diameter is less than 80 nm, there is an inconvenience such that thickening may take place at a predetermined composition in producing a paste. The shape of the particles for joining material is not limited to spherical shape, but may be needle-shape or flat-plate shape. Since the melting point of the copper nanoparticles as base powder is 1085° C., joints of the joining film, etc. after a paste for joining is applied or coated and is then subjected to reflow process have excellent thermal resistance.

The organic protective film 12 is a citric acid derived film, and serves to coat the surface of the copper nanoparticles as base particles 11 thus to prevent oxidation of the copper nanoparticles during preservation from the completion of production until they result in a paste for joining. This organic protective film 12 is included in a range of 0.5% to 2.0% by mass, preferably 0.8% to 1.8% by mass with respect to 100% by mass of the particles for joining material. When the coating amount or the content of the organic protective film 12 is less than 0.5% by mass, there results the state where the organic protective film does not completely cover or coat the copper nanoparticle so that a portion of the copper nanoparticles results in an oxide. For this reason, sintering of the particles for joining material does not proceed at the time of joining. In addition, when the coating amount or the content of the organic protective film 12 is above 2.0% by mass, voids take place at joints of the joining film, etc. resulting from gas produced by desorption of the organic protective film at the time of joining so that the joining strength may be lowered.

In the particles for joining material according to this embodiment, since the organic protective film coats or covers the copper nanoparticles of the base particles in a ratio of 0.5% to 2.0% by mass, when heated for 30 minutes at a temperature of 300° C. under the inert gas atmosphere such as nitrogen gas or argon gas, etc., the organic protective film is decomposed not less than 50% by mass. In addition, because of the citric acid derived organic protective film, vaporized gas and vapor water of carbon dioxide gas, nitrogen gas or acetone are produced at the time of decomposition.

The particles 10 for joining material is such that when analyzed by using the Time-of-Flight Secondary ion Mass Spectrometry (TOF-SIMS), respective detected amounts of C₃H₃O₃⁻ ions and C₃H₄O₂⁻ ions are in a range of 0.05 times to 0.2 times a detected amount of the Cu⁺ ions, and a detected amount of ions of C₅ or more is in a range less than 0.005 times the detected amount of Cu⁺ ions.

C₃H₃O₃⁻ ions and C₃H₄O₂⁻ ions, and/or ions of C₅ or more with respect to Cu⁺ ions which are detected in the Time-of-Flight Secondary ion Mass Spectrometry (TOF-SIMS) derive from the organic protective film which covers or coats the surface of the copper nanoparticles. For this reason, when respective detected amounts of C₃H₃O₃⁻ ions and C₃H₄O₂-ions are less than 0.05 times the detected amount of Cu⁺ ions, the amount of the organic protective film which coats the surface of the copper nanoparticles becomes too lesser so that the surface of the copper nanoparticles becomes active thus to facilitate the copper nanoparticle to be oxidized, and to facilitate the copper nanoparticles to be aggregated. As a result, when it is changed to a paste for joining, the viscosity of the paste is increased so that the coating property may be lowered. On the other hand, when respective detected amounts of C₃H₃O₃⁻ ions and C₃H₄O₂⁻ ions are above 0.2 times the detected amount of Cu⁺ ions, gas voids (air holes) take place at the time of forming a joined body. For this reason, the joining strength may be apt to be lowered. Moreover, the amount of the organic protective film which coats or covers the surface of the copper nanoparticles becomes too large so that the sinterability of the particles for joining material is lowered, and it becomes thus necessary to increase the heating temperature for sintering the particles for joining material. For the purpose of improving, to more degree, oxidation resistance during preservation of the particles for joining material and improving, to more degree, the low temperature sinterability at the time of joining, it is preferable that respective detected amounts of C₃H₃O₃⁻ ions and C₃H₄O₂⁻ ions are in a range of 0.08 times to 0.16 times the detected amount of Cu⁺ ions, and it is preferable that the detected amount of ions of C₅ or more is in a range less than 0.003 times the detected amount of Cu⁺ ions. In addition, when the detected amount of ions of C₅ or more is 0.005 times or more the Cu⁺ ions detected in the Time-of-Flight Secondary ion Mass Spectrometry (TOF-SIMS), the reduction reaction is insufficient so that such particles cannot be suitably used as joining material.

### [Method of Producing Particles for Joining Material]

The particles for joining material according to the present embodiment are produced by a method comprising; adding a pH adjusting agent into an aqueous dispersion containing copper citrate thus to perform pH adjustment so that the pH is not less than 3 and is not more than 7; adding and mixing hydrazine compound as a reducing agent, which is not less than 1.0 times equivalent and is not more than 1.2 times equivalent, which can reduce copper ions, into an aqueous dispersion of the pH adjusted copper citrate under the inert gas atmosphere; heating this mixed solution under the inert gas atmosphere so that its temperature is not less than 60° C. and is not more than 80° C.; and holding the heated mixed solution for a time period of 1.5 hours to 2.5 hours to thereby reduce the copper citrate to produce copper nanoparticles to form an organic protective film on the surface of the copper nanoparticles.

The aqueous dispersion of the copper citrate is prepared by adding copper citrate in the form of powder into pure water such as distilled water or ion exchanged water so that its concentration is not less than 25% by mass and is not more than 40% by mass to perform stirring up by using stirring blade to uniformly disperse it. As the pH adjusting agent, there are mentioned triammonium citrate, ammonium hydrogen citrate, and citric acid, etc. Because pH adjustment is easy to be made in a mild manner thereamong, it is preferable to adopt triammonium citrate. The reason why the pH adjustment by the pH adjusting agent is set to pH 3 or more and less than pH 7 is that elution of copper ions from the copper citrate is slow at less than pH 3, and the reaction is thus difficult to rapidly proceed so that target particles cannot be easily obtained. Moreover, at pH 7 or more, when the copper citrate is reduced by hydrazine compound, eluted copper ions are apt to result in copper (II) hydroxide and are apt to precipitate so that particles for joining material cannot be produced in a high yield. In addition, since the reducing power of the hydrazine is enhanced so that reaction becomes easy to proceed, target particles are difficult to be obtained. The preferred pH is not less than 4 and is not more than 6.

The reduction of the copper citrate by the hydrazine compound is performed under the inert gas atmosphere. This serves to prevent oxidation of copper eluted into a solution. As the inert gas, there are mentioned nitrogen gas, and argon gas, etc. The hydrazine compound has the advantages that no residue takes place after reduction reaction, the safety is relatively high, and handling is easy, tec. at the time of reducing copper citrate under the acidic condition. As the hydrazine compound, there are mentioned hydrazine-hydrate, anhydrous hydrazine, hydrazine chloride, and hydrazine sulphate, etc. Because it is desirable that any component which may result in impurities such as sulfur or chlorine does not exist, hydrazine-hydrate is preferable thereamong.

In general, copper produced in an acid solution having less than pH 7 would be dissolved. However, in this embodiment, when hydrazine compound as a reducing agent is added and mixed into an acid solution having less than pH 7 so that copper nanoparticles are produced in the solution, citric ion derived components produced from the copper citrate rapidly coat or cover the surface of the copper nanoparticle surfaces to suppress dissolution of the copper nanoparticles. It is preferable that the acid solution having less than pH 7 is caused to have a temperature which is not less than 50° C. and is not more than 70° C. so that reduction reaction is easy to proceed.

The reason why there is employed such an approach to heat, under the inert gas atmosphere, a mixed solution in which hydrazine compound is mixed so as to have a temperature which is not less than 60° C. and is not more than 80° C. to hold the heated mixed solution for a time period which is not less than 1.5 hours and is not more than 2.5 hours is to reduce the copper citrate to produce copper nanoparticles to form copper citrate derived organic protective film on the surfaces of the copper nanoparticles in a range of 0.5% to 2.0% by mass to perform coating thereof. The reason why heating/holding is performed under the inert gas atmosphere is to prevent oxidation of copper nanoparticles. The copper citrate as the starting material ordinarily includes copper component of about 35% by mass. By adding hydrazine compound as a reducing agent into copper citrate containing copper component to such degree to perform heating so as to raise the temperature up to the above-mentioned temperature range to hold it for a predetermined time, reduction of the copper citrate proceeds so that particles having a copper component which is not less than 98% by mass and is not more than 99.5% by mass are provided. The ingredient amounts other than the copper component of the particles which are not less than 0.5% by mass and are not more than 2.0% by mass results in organic protective film. When the heating temperature is less than 60° C. and the holding time is less than 1.5 hours, the copper citrate is not completely reduced, and the copper component does not result in particles of 98% by mass or more so that the amount of the organic protective film coated or formed exceeds 2.0% by mass. Thus, as described above, voids take place at joints of the joining film, etc. resulting from gas produced by desorption of the organic protective film at the time of joining so that the joining strength would be lowered. Moreover, when the heating temperature is above 80° C. and the holding time is above 2.5 hours, the copper component exceeds 99.5% by mass so that the amount of the organic protective film coated or formed results in less than 0.5% by mass. Thus, as described above, the organic protective film results in the state where it does not completely coat the copper nanoparticles so that a portion of the copper nanoparticles results in oxide. For this reason, sintering of particles for joining material does not proceed at the time of joining. A preferred heating temperature is not less than 65° C. and is not more than 75° C., and a preferred holding time is not less than 2 hours and is not more than 2.5 hours.

By allowing the particles produced in the solution where the copper citrate is reduced to be subjected to solid-liquid separation by using, e.g., the centrifugal separator from this solution under the inert gas atmosphere to dry them by the freeze-drying method or the decompression-drying method, there are provided particles for joining material including the organic protective film on the surfaces of the above-described copper nanoparticles which are target particles. Since these particles for joining material are adapted so that the surface of the copper nanoparticles is coated with the organic protective film, even if they are stored or preserved in the atmosphere until they are used as the paste for joining, it is possible to prevent oxidation of particles.

### [Paste for Joining]

The paste for joining including the particles for joining material and a volatile solvent will now be described. As the volatile solvent, there are mentioned alcohol-based solvent, glycol-based solvent, acetate-based solvent, hydrocarbon-based solvent and amine-based solvent. As a practical example of the alcohol-based solvent, there are mentioned α-terpineol and isopropyl alcohol. As a practical example of the glycol-based solvent, there are mentioned ethylene glycol, diethylene glycol, and polyethylene glycol. As a practical example of the acetate-based solvent, there is mentioned butyl carbitol acetate. As a practical example of the hydrocarbon-based solvent, there are mentioned decane, dodecane, and tetradecane. As a practical example of the amine-based solvent, there are mentioned hexylamine, octylamine and dodecylamine.

It is preferable that the content of particles for joining material in the paste for joining is 50% by mass or more with respect to the total amount of the paste for joining, and it is particularly preferable that it is in a range of 70% to 95% by mass. When the content of the particles for joining material falls within the above-mentioned range, the viscosity of the paste for joining does not become too low, and it is thus possible to stably coat or cover the paste for joining on the surface of the member. Moreover, by baking the paste for joining, it is possible to provide a sintered body (joining layer) having a high density and a lesser amount of voids produced. In addition, the paste for joining may include additive agent such as antioxidant, and/or viscosity modifier, etc. It is preferable that the contents of these additive agents are in a range of 1% to 5% by mass with respect to 100% by mass of the paste for joining.

### [Method of Preparing Paste for Joining]

The paste for joining can be produced by kneading, by using a kneading device or mixer, a mixture obtained by mixing, e.g. volatile solvent and particles for joining material. As the kneading device, there is mentioned three-rollers milling machine.

### [Method of Producing Joined Body]

The joined body according to this embodiment is produced through: a step of coating or applying the above-described paste for joining onto the surface of a substrate or an electronic component to form a coated layer; a step of overlapping the substrate and the electronic component with each other through the coated layer; and a step of heating, at a temperature which is not less than 200° C. and is not more than 300° C. under an inert gas atmosphere, the substrate and the electronic component which have been overlapped with each other while applying a pressure of 30 MPa or less thereto to sinter the coated layer to thereby form a joining layer thus to join the substrate and the electronic component by the joining layer.

As the substrate, although not particularly limited, there are mentioned base materials for mounting semiconductor device, e.g., oxygen-free copper plate, copper-molybdenum plate, high heat dissipation insulating substrate (e.g., DBC (Direct Copper Bond), and LED (Light Emitting Diode) package, etc. Moreover, as the electronic component, there are mentioned semiconductor devices such as IGBT (Insulated Gate Bipolar Transistor), diode, Schottky-barrier diode, MOS-FET (Metal Oxide Semiconductor Field Effect Transistor), thyristor, logic, sensor, analog integrated circuit, LED, semiconductor laser, and/or oscillator, etc. As the coating method, there are mentioned, although not particularly limited, e.g., spin-coating method, metal-mask method, spray coating method, dispenser coating method, knife coating method, slit coating method, inkjet coating method, screen printing method, offset printing method, and die coating method, etc.

After the coated layer is formed, the substrate and the electronic component are overlapped with each other through the coated layer. It is preferable that the thickness of the coated layer is uniform. The substrate and the electronic component which have been overlapped with each other are heated at a temperature which is not less than 200° C. and is not more than 300° C. under the inert gas atmosphere while applying a pressure of 30 MPa or less thereto. When a pressure applied is above 30 MPa, there is the possibility that any mechanical damage may be applied to the substrate or the electronic component. It is preferable that a pressure applied is not less than 5 MPa, and is not more than 30 MPa. When the pressure applied is less than 5 MPa, there is the possibility that copper nanoparticles in the coated layer may become difficult to be sintered so that joining layer fails to be produced. Moreover, for the atmosphere, in view of the fact that no ignition might take place by fire and oxidation of the joined body can be prevented, an inert gas atmosphere such as nitrogen gas or argon gas, etc. is specified. In addition, when the heating temperature is less than 200° C., copper nanoparticles in the coated layer become difficult to be sintered, resulting in the possibility that the joining layer may fail to be formed. On the other hand, when it exceeds 300° C., there is the possibility that thermal damage may be applied to the substrate or the electronic component. The preferred heating temperature is not less than 230° C., and is not more than 300° C.

In this way, by heating the substrate and the electronic component which have been overlapped with each other at a temperature which is not less than 200° C. and is not more than 300° C. under the inert atmosphere while applying pressure thereto, copper nanoparticles in the coated layer are sintered so that a joined body according to this embodiment is produced.

### EXAMPLES

Examples of the present invention will now be described in detail along with comparative examples.

### Example 1

First, commercially available copper citrate.2.5 hydrate (made by Wako Pure Chemical Corporation) which is the starting material was added into an ion exchanged water of a room temperature to stir up it by means of stirring blade to prepare an aqueous dispersion of a copper citrate having a concentration of 30% by mass. Next, an ammonium citrate aqueous solution as the pH adjusting agent was added into the aqueous dispersion of the copper citrate to make adjustment so that the pH of the aqueous dispersion becomes equal to 3. Next, the pH adjusted solution was caused to have a temperature of 50° C. to immediately add, as a reducing agent, hydrazine-hydrate aqueous solution (doble dilution) of 1.2 times equivalent which can reduce copper ions into the pH adjusted solution under the nitrogen gas atmosphere to uniformly blend or mix them by using the stirring blade. Further, for the purpose of synthesizing target particles for joining material, the temperature of the mixed solution of the aqueous dispersion and the reducing agent was raised until the maximum temperature of 70° C. under the nitrogen gas atmosphere to hold it for two hours at the 70° C. The particles produced in the solution which has been heated and held were subjected to solid-liquid separation by using the centrifugal separator so that they are collected. These particles thus collected were dried by the decompression-drying method to produce particles for joining material of the example 1. A microscopic photographic diagram in which the aggregate of the particles for joining material of the example 1 is photographed at a magnification of 30,000 times was illustrated in FIG. 2. It is seen from FIG. 2 that the aggregate of the particles for joining material of the example 1 is of a configuration including particles of order of hundred nanometers. The conditions for producing particles for joining material of the example 1 and examples 2 to 11 and comparative examples 1 to 9 which will be described below are illustrated in the following Table 1.

TABLE 1

| | Condition for producing particles for joining materials | | | | | |
|---|---|---|---|---|---|---|
| | | | | Oxidation- | Maximum | |
| | | | | reduction | temperature | |
| | | Adjusted | | potential E(V) | at the time | Holding |
| | Starting | pH of | Reducing | of reducing | of synthesis | time |
| | material | solution | agent | agent | (° C.) | (Hr) |
| Example 1 | Copper citrate | 3 | Hydrazine-hydrate | −0.5 | 70 | 2.0 |
| Example 2 | Copper citrate | 4 | Hydrazine-hydrate | −0.5 | 70 | 2.0 |
| Example 3 | Copper citrate | 5 | Hydrazine-hydrate | −0.6 | 70 | 2.0 |
| Example 4 | Copper citrate | 6 | Hydrazine-hydrate | −0.7 | 70 | 2.0 |
| Example 5 | Copper citrate | 5 | Hydrazine-hydrate | −0.6 | 70 | 1.5 |
| Example 6 | Copper citrate | 5 | Hydrazine-hydrate | −0.6 | 70 | 2.5 |
| Example 7 | Copper citrate | 5 | Hydrazine-hydrate | −0.6 | 60 | 2.5 |
| Example 8 | Copper citrate | 5 | Hydrazine-hydrate | −0.6 | 80 | 1.5 |
| Example 9 | Copper citrate | 4 | Anhydrous hydrazine | −0.6 | 70 | 2.0 |
| Example 10 | Copper citrate | 4 | Chloride hydrazine | −0.6 | 70 | 2.0 |
| Example 11 | Copper citrate | 4 | Sulphate hydrazine | −0.6 | 70 | 2.0 |
| Comparative example 1 | Copper citrate | 2 | Hydrazine-hydrate | −0.4 | 70 | 2.0 |
| Comparative example 2 | Copper citrate | 8 | Hydrazine-hydrate | −0.9 | 70 | 2.0 |
| Comparative example 3 | Copper citrate | 10 | Hydrazine-hydrate | −1.0 | 70 | 2.0 |
| Comparative example 4 | Copper citrate | 5 | Ammonium formate | 0.3 | 70 | 2.0 |
| Comparative example 5 | Copper citrate | 3 | Formic acid | −0.2 | 70 | 2.0 |
| Comparative example 6 | Copper citrate | 5 | Hydrazine-hydrate | −0.6 | 70 | 1.0 |
| Comparative example 7 | Copper citrate | 5 | Hydrazine-hydrate | −0.6 | 70 | 3.0 |
| Comparative example 8 | Copper citrate | 5 | Hydrazine-hydrate | −0.6 | 85 | 1.5 |
| Comparative example 9 | Copper citrate | 5 | Hydrazine-hydrate | −0.6 | 55 | 2.5 |

### Examples 2 to 11, Comparative Examples 1 to 3 and Comparative Examples 6 to 9

In the examples 2 to 8, pH of aqueous dispersion of the copper citrate illustrated in the example 1 was changed as shown in the Table 1 without changing the starting material and the reducing agent of the example 1 to thereby change the oxidation-reduction potential E of the reducing agent to change or hold the maximum temperatures and their holding times at the time of synthesizing particles for joining material. In a manner similar to the example 1 except for the above, particles for joining material of examples 2 to 8, the comparative examples 1 to 3 and the comparative examples 6 to 9 were produced. In the examples 9 to 11, anhydrous hydrazine was used as the reducing agent to set oxidation-reduction potential E of the reducing agent to −0.6 V, to set the maximum temperature at the time of synthesis to 70° C., and to set the holding time thereof to 2.0 hours.

It is known that the hydrazine-based reducing agent including hydrazine-hydrate exhibits reaction in the acidic region and that in the alkaline region which are different from each other. Moreover, in the examples 2 to 11, the comparative examples 1 to 3 and the comparative examples 6 to 9, pH in the reaction solution was varied to thereby allow reducing powers to be different from each other. In the Table 1, oxidation-reduction potentials E (V) at the respective conditions are shown in the Table 1.

N₂H₅⁺=N₂+5H⁺+4e⁻ (Acidic region)

N₂H₄+4OH⁻=N₂+4H₂O+4e⁻ (Alkaline region)

Oxidation-reduction potential E: −0.23-0.975 pH

### Comparative Example 4

There was employed an approach to change the hydrazine-hydrate as the reducing agent of the example 1 to ammonium formate, and to change the oxidation-reduction potential E of the reducing agent (E: 0.3 V). There was further employed an approach to change pH values of aqueous dispersions of copper citrate without changing the maximum temperature and the holding time thereof at the time of synthesis of the example 1 to produce the particles for joining material of the comparative example 4 similarly to the example 1 except for the above.

### Comparative Example 5

There was employed an approach to change hydrazine-hydrate as the reducing agent of the example 1 to formic acid, and to change the oxidation-reduction potential E of the reducing agent (E: −0.2 V). There were not changed pH value of the aqueous dispersion, the maximum temperature at the time of synthesis and its holding time of the copper citrate of the example 1. Particles for joining material of the comparative example 5 were produced similarly to the example 1 except for the above.

### <Comparative Evaluation Test and Results>

There were respectively calculated or measured respective production yields of particles when particles for joining material are produced in the examples 1 to 11 and the comparative examples 1 to 9, and base particle compositions, BET specific surface areas and BET diameters, respective detected amounts of C₃H₃O₃⁻ ions and C₃H₄O₂⁻ ions with respect to the detected amount of Cu⁺ ions by the Time-Of-Flight Secondary Ion Mass Spectrometry (TOF-SIMS) relating to the organic protective film, and detected amounts of ions of C₅ or more of 20 kinds of particles for joining material which are obtained in the examples 1 to 11 and the comparative examples 1 to 9. These results are shown in the following Table 2.

TABLE 2

| | Particles for joining material | | | | Characteristic 1 of organic protective film | | |
|---|---|---|---|---|---|---|---|
| | | | BET | | Time of flight secondary ion mass spectrometry | | |
| | Production | Base | specific | BET | | | Not less than |
| | yield | particle | surface area | diameter | C₃H₃O₃ ⁻ ion/ | C₃H₄O₂ ⁻ ion/ | C₅ ion/ |
| | (%) | composition | (m²/g) | (nm) | Cu⁺ ion | Cu⁺ ion | Cu⁺ ion |
| Example 1 | 91 | Cu | 7.8 | 89 | 0.05 | 0.06 | 0.002 |
| Example 2 | 95 | Cu | 4.8 | 140 | 0.12 | 0.14 | No detection |
| Example 3 | 97 | Cu | 4.7 | 148 | 0.15 | 0.16 | No detection |
| Example 4 | 95 | Cu | 3.5 | 192 | 0.08 | 0.19 | No detection |
| Example 5 | 90 | Cu | 6.2 | 108 | 0.19 | 0.16 | 0.002 |
| Example 6 | 97 | Cu | 4.3 | 156 | 0.09 | 0.12 | No detection |
| Example 7 | 90 | Cu | 6.5 | 103 | 0.14 | 0.15 | 0.001 |
| Example 8 | 95 | Cu | 4.9 | 137 | 0.09 | 0.06 | No detection |
| Example 9 | 95 | Cu | 5.0 | 134 | 0.11 | 0.13 | No detection |
| Example 10 | 95 | Cu | 5.3 | 127 | 0.11 | 0.14 | No detection |
| Example 11 | 95 | Cu | 4.8 | 140 | 0.13 | 0.13 | No detection |
| Comparative example 1 | Calculation | Cu | — | — | — | — | — |
| | Impossible | | | | | | |
| Comparative example 2 | 90 | Cu | 1.9 | 353 | 0.21 | 0.48 | 0.004 |
| Comparative example 3 | 80 | Cu | 1.8 | 373 | 0.30 | 0.59 | 0.010 |
| Comparative example 4 | Calculation | Cu | — | — | — | — | — |
| | Impossible | | | | | | |
| Comparative example 5 | Calculation | Cu | — | — | — | — | — |
| | Impossible | | | | | | |
| Comparative example 6 | Calculation | Cu | — | — | — | — | — |
| | Impossible | | | | | | |
| Comparative example 7 | 97 | Cu | 2.5 | 268 | 0.04 | 0.05 | No detection |
| Comparative example 8 | 96 | Cu | 2.9 | 231 | 0.03 | 0.04 | No detection |
| Comparative example 9 | Calculation | Cu | — | — | — | — | — |
| | Impossible | | | | | | |

Moreover, there were respectively calculated or measured mass ratios with respect to particles for joining material of the organic protective film, the decomposition amount ratios of the organic protective film under the nitrogen atmosphere, and gas components produced at the time of baking particles for joining material. These results are shown in the following Table 3. In connection with particles which could not calculate production yields because of insufficient reduction (the comparative example 1, the comparative examples 4 to 6, the comparative example 9), the BET specific surface area, the BET diameter, the characteristic of the organic protective film are not measured.

TABLE 3.1

| | | | Gas component |
|---|---|---|---|
| | Characteristic 1 of organic protective film | | produced at the |
| | Mass ratio | Decomposition amount ratio | time of baking |
| | (percentage by | under nitrogen atmosphere | particles for |
| | mass) | (%) | joining material |
| Example 1 | 1.8 | 75 | N₂, H₂O, CO₂, C₃H₆O |
| Example 2 | 1.4 | 78 | N₂, H₂O, CO₂, C₃H₆O |
| Example 3 | 0.8 | 80 | N₂, H₂O, CO₂, C₃H₆O |
| Example 4 | 0.5 | 85 | N₂, H₂O, CO₂, C₃H₆O |
| Example 5 | 2.0 | 80 | N₂, H₂O, CO₂, C₃H₆O |
| Example 6 | 1.1 | 82 | N₂, H₂O, CO₂, C₃H₆O |
| Example 7 | 1.7 | 81 | N₂, H₂O, CO₂, C₃H₆O |
| Example 8 | 1.2 | 88. | N₂, H₂O, CO₂, C₃H₆O |
| Example 9 | 1. 3 | 88 | N₂, H₂O, CO₂, C₃H₆O |
| Example 10 | 1.4 | 85 | N₂, H₂O, CO₂, C₃H₆O |
| Example 11 | 1.3 | 83 | N₂, H₂O, CO₂, C₃H₆O |
| Comparative Example 1 | 2.5 | — | — |
| Comparative Example 2 | 0.4 | 70 | N₂, H₂O, CO₂, C₃H₆O |
| Comparative Example 3 | 0.2 | 72 | N₂, H₂O, CO₂, C₃H₆O |
| Comparative Example 4 | 35 | — | — |
| Comparative Example 5 | 35 | — | — |
| Comparative Example 6 | 16 | — | — |
| Comparative Example 7 | 0.4 | 82 | N₂, H₂O, CO₂, C₃H₆O |
| Comparative Example 8 | 0.5 | 78 | N₂, H₂O, CO₂, C₃H₆O |
| Comparative Example 9 | 25 | — | — |

### (1) Production Yield of Particles

For the production yield of particles, ratios of collected powder amount after drying when the amount of copper included in the copper citrate is assumed to be theoretical amount were determined as the production yield.

### (2) BET Specific Surface Area of Particles

The specific surface areas of particles were determined from adsorption amount of N₂ gas into cooled particles for joining material by using QUANTACHROME AUTOSORB-1 (made by Quantachrome instruments) as a measuring apparatus.

### (3) BET Diameter of Particle

The BET diameters of particles respectively indicate theoretical diameters in the case where copper nanoparticles are assumed to be perfect spherical body, which are obtained by calculating, after the specific surface areas (BET method) are measured, their areas on the premise that those particles are all spherical body.

### (4) Measurement Based on the Time-of-Flight Secondary Ion Mass Spectrometry

For respective detections of C₃H₃O₃⁻ ions and C₃H₄O₂⁻ ions, and/or ion of C₅ or more with respect to Cu⁺ ions, respective measurements were made as below by using the Time-Of-Flight Secondary Ion Mass Spectrometry (TOF-SIMS). A substance including copper powder embedded at the In foil surface was employed as a sample for measurement. For the measurement equipment, nanoTOFII made by ULVAC PHI company was used. Measurement was performed under the condition where the measurement range is a range of 100 μm square, the primary ion is Bi₃⁺⁺ (30 kV), and the measurement time is 5 minutes to obtain TOF-SIMS spectrum. From the TOF-SIMS spectrum thus obtained, detected amounts of Cu⁺ ions, C₃H₃O₃⁻ ions and C₃H₄O₂⁻ ions, and ions of C₅ or more were determined. These detected amounts of C₃H₃O₃⁻ ions and C₃H₄O₂⁻ ions, and ions of C₅ or more were respectively divided by the detected amount of Cu⁺ ions to calculate detected amounts of C₃H₃O₃⁻ ions, C₃H₄O₂⁻ ions and ions of C₅ or more with respect to Cu⁺ ions.

### (5) Mass Ratio of the Organic Protective Film in the Particles for Joining Material

For the mass ratio of the organic protective film in the particles for joining material, there was employed an approach to weigh particles for joining material to heat them for 30 minutes at a temperature of 300° C. under nitrogen atmosphere thereafter to cool them down to a room temperature to measure masses of the metallic particle aggregates. Calculation was performed from the following formula.

Mass ratio (% by mass) of the organic protective film in the particles for joining material=(A−B)/A×100

where A is a mass of the particles for joining material before heating, and B is a mass of the particles for joining material after heating.

### (6) Decomposition Amount Ratio of the Organic Protective Film Under the Nitrogen Atmosphere

For the decomposition amount ratio of the organic protective film, there is employed an approach to heat, in accordance with the same method as the method of calculating the mass ratio of the organic protective film, particles for joining material under the nitrogen atmosphere for 30 minutes at a temperature of 500° C. to determine, as the decomposition amount ratio, the ratio of a decrease amount under the condition of 300° C. with respect to a decrease amount under the condition of 500° C.

### (7) Gas Component Produced at the Time of Baking Particles for Joining Material

For gas component produced at the time of baking particles for joining material, gas components produced from a room temperature up to 300° C. were identified by using the pyrolytic gas-chromatography.

### (8) Production Condition, Joining Condition and Joining Strength of Joined Body

By mixing 15 kinds of particles for joining material which have been obtained in the example 1 to 11 and the comparative examples 2, 3, 7 and 8 with ethylene glycol (EG) as a volatile solvent, a paste for joining was prepared. More specifically, solvent and particles were contained into a vessel made of polypropylene in a ratio of ethylene glycol of 85% by mass and particles for joining material of 15% by mass to implement kneading or mixing thereof by means of kneader or mixer (made by THINKY, Awatori Rentaro). Preliminary kneading was performed under the condition of kneading: 1,000 rpm×60 sec and defoaming: 1,000 rpm×60 sec to respectively set Gap widths to 50 μm at the first time, 10 μm at the second time and 5 μm at the third time by using the three rollers (made by EXACT, 80E) to perform kneading on a full scale. Thus, the paste for joining was prepared.

Printing was performed onto an oxygen-free copper plate (0.8 mmt) by using metal mask plate (2.5 mm, 50 μmt) in which the paste for joining was set at the metal mask printing machine to implement preliminary drying for 30 minutes at room temperature thereafter to mount Si dummy device thereon. Regarding the baking condition, joining temperature was set to four levels of 200° C., 230° C., 250° C. and 300° C. under the nitrogen atmosphere by using the pressure-joining apparatus (made by Ayumi kogyou, RB-50). Moreover, the joining load was set to 10 MPa when the joining temperature is 300° C., to 20 MPa when the joining temperature is 230° C. and 250° C., and to 30 MPa when the joining temperature is 200° C. The temperature rising rate was 30° C./min, and the joining holding time was set to 15 minutes when the joining temperature is 230° C., 250° C. and 300° C. and to 30 minutes when the joining temperature is 200° C.

Joined bodies were produced under the above-described joining condition. The joined bodies thus obtained were evaluated in regard to their joining strengths by using the bonding tester (made by ORIENTEC TENSILON RTF-1310), and joined body or bodies in which the strength of 15 MPa or more is obtained was or were evaluated to be satisfactory. These results are shown in the following Tables 4 to 6a, 6b.

TABLE 4

| | | | | Solvent | | Joining material | | | | | |
|---|---|---|---|---|---|---|---|---|---|---|---|
| | | | | | Mixing | | Mixing | | | | |
| | Substrate | | | | amount | | amount | Joining condition | | | Joining |
| | | | Thickness | | (part | | (part | | Temperature | Pressure | strength |
| | Material | Plating | (nm) | Kind | by mass) | Material | by mass) | Atmosphere | (° C.) | (MPa) | (MPa) |
| Example 1 | Oxygen | Non | 0.8 | EG | 15 | Cu | 85 | N₂ | 200 | 25 | 16 |
| | free | | | | | | | | 230 | 20 | 35 |
| | copper | | | | | | | | 250 | 20 | 35 |
| | | | | | | | | | 300 | 10 | 50 |
| Example 2 | Oxygen | Non | 0.8 | EG | 15 | Cu | 85 | N₂ | 200 | 25 | 19 |
| | free | | | | | | | | 230 | 20 | 22 |
| | copper | | | | | | | | 250 | 20 | 32 |
| | | | | | | | | | 300 | 10 | 48 |
| | Oxygen | Au | 0.8 | EG | 15 | Cu | 85 | N₂ | 200 | 25 | 16 |
| | free | | | | | | | | 230 | 20 | 22 |
| | copper | | | | | | | | 250 | 20 | 30 |
| | | | | | | | | | 300 | 10 | 45 |
| | Oxygen | Ag | 0.8 | EG | 15 | Cu | 85 | N₂ | 200 | 25 | 16 |
| | free | | | | | | | | 230 | 20 | 20 |
| | copper | | | | | | | | 250 | 20 | 28 |
| | | | | | | | | | 300 | 10 | 40 |
| Example 3 | Oxygen | Non | 0.8 | EG | 15 | Cu | 85 | N₂ | 200 | 25 | 21 |
| | free | | | | | | | | 230 | 20 | 31 |
| | copper | | | | | | | | 250 | 20 | 38 |
| | | | | | | | | | 300 | 10 | 47 |

TABLE 5

| | | | | Solvent | | Joining material | | | | | |
|---|---|---|---|---|---|---|---|---|---|---|---|
| | | | | | Mixing | | Mixing | | | | |
| | Substrate | | | | amount | | amount | Joining condition | | | Joining |
| | | | Thickness | | (part | | (part | | Temperature | Pressure | strength |
| | Material | Plating | (nm) | Kind | by mass) | Material | by mass) | Atmosphere | (° C.) | (MPa) | (MPa) |
| Example 4 | Oxygen | Non | 0.8 | EG | 15 | Cu | 85 | N₂ | 200 | 25 | 15 |
| | free | | | | | | | | 230 | 20 | 25 |
| | copper | | | | | | | | 250 | 20 | 39 |
| | | | | | | | | | 300 | 10 | 48 |
| Example 5 | Oxygen | Non | 0.8 | EG | 15 | Cu | 85 | N₂ | 200 | 25 | 15 |
| | free | | | | | | | | 230 | 20 | 21 |
| | copper | | | | | | | | 250 | 20 | 41 |
| | | | | | | | | | 300 | 10 | 48 |
| Example 6 | Oxygen | Non | 0.8 | EG | 15 | Cu | 85 | N₂ | 200 | 25 | 17 |
| | free | | | | | | | | 230 | 20 | 25 |
| | copper | | | | | | | | 250 | 20 | 39 |
| | | | | | | | | | 300 | 10 | 45 |
| Example 7 | Oxygen | Non | 0.8 | EG | 15 | Cu | 85 | N₂ | 200 | 25 | 20 |
| | free | | | | | | | | 230 | 20 | 25 |
| | copper | | | | | | | | 250 | 20 | 37 |
| | | | | | | | | | 300 | 10 | 52 |
| Example 8 | Oxygen | Non | 0.8 | EG | 15 | Cu | 86 | N₂ | 200 | 25 | 18 |
| | free | | | | | | | | 230 | 20 | 25 |
| | copper | | | | | | | | 250 | 20 | 31 |
| | | | | | | | | | 300 | 10 | 49 |

TABLE 6a

| | | | | Solvent | | Joining material | | | | | |
|---|---|---|---|---|---|---|---|---|---|---|---|
| | | | | | Mixing | | Mixing | | | | |
| | Substrate | | | | amount | | amount | Joining condition | | | Joining |
| | | | Thickness | | (part | | (part | | Temperature | Pressure | strength |
| | Material | Plating | (nm) | Kind | by mass) | Material | by mass) | Atmosphere | (° C.) | (MPa) | (MPa) |
| Example 9 | Oxygen | Non | 0.8 | EG | 15 | Cu | 85 | N₂ | 200 | 25 | 19 |
| | free | | | | | | | | 230 | 20 | 25 |
| | copper | | | | | | | | 250 | 20 | 38 |
| | | | | | | | | | 300 | 10 | 50 |
| Example 10 | Oxygen | Non | 0.8 | EG | 15 | Cu | 85 | N₂ | 200 | 25 | 19 |
| | free | | | | | | | | 230 | 20 | 22 |
| | copper | | | | | | | | 250 | 20 | 35 |
| | | | | | | | | | 300 | 10 | 46 |
| Example 11 | Oxygen | Non | 0.8 | EG | 15 | Cu | 85 | N₂ | 200 | 25 | 16 |
| | free | | | | | | | | 230 | 20 | 24 |
| | copper | | | | | | | | 250 | 20 | 31 |
| | | | | | | | | | 300 | 10 | 49 |

TABLE 6b

| | | | | Solvent | | Joining material | | | | | |
|---|---|---|---|---|---|---|---|---|---|---|---|
| | | | | | Mixing | | Mixing | | | | |
| | Substrate | | | | amount | | amount | Joining condition | | | Joining |
| | | | Thickness | | (part | | (part | | Temperature | Pressure | strength |
| | Material | Plating | (nm) | Kind | by mass) | Material | by mass) | Atmosphere | (° C.) | (MPa) | (MPa) |
| Comparative | No implementation because powder cannot be obtained. | | | | | | | | | | |
| example 1 | | | | | | | | | | | |
| Comparative | Oxygen | Non | 0.8 | EG | 15 | Cu | 85 | N₂ | 300 | 10 | 4 |
| example 2 | free | | | | | | | | | | |
| | copper | | | | | | | | | | |
| Comparative | Oxygen | Non | 0.8 | EG | 15 | Cu | 85 | N₂ | 300 | 10 | 8 |
| example 3 | free | | | | | | | | | | |
| | copper | | | | | | | | | | |
| Comparative | No implementation because powder cannot be obtained. | | | | | | | | | | |
| example 4 | | | | | | | | | | | |
| Comparative | No implementation because powder cannot be obtained. | | | | | | | | | | |
| example 5 | | | | | | | | | | | |
| Comparative | No implementation because powder cannot be obtained. | | | | | | | | | | |
| example 6 | | | | | | | | | | | |
| Comparative | Oxygen | Non | 0.8 | EG | 15 | Cu | 85 | N₂ | 300 | 10 | 10 |
| example 7 | free | | | | | | | | | | |
| | copper | | | | | | | | | | |
| Comparative | Oxygen | Non | 0.8 | EG | 15 | Cu | 85 | N₂ | 300 | 10 | 12 |
| example 8 | free | | | | | | | | | | |
| | copper | | | | | | | | | | |
| Comparative | No implementation because powder cannot be obtained. | | | | | | | | | | |
| example 9 | | | | | | | | | | | |

As apparent from the tables 1 to 3 and the Table 6a, 6b, since the reducing agent is added and mixed under strong acidic condition of pH 2 in the comparative example 1, although the synthetic solution was heated for 2 hours at 70° C., reduction of the copper citrate was not completed. As a result, the mass ratio of the organic protective film was also high so that target particles cannot be produced.

Since the reducing agent is added and mixed under alkaline condition of pH 8 in the comparative example 2, copper ions changed to the copper (II) hydroxide in the solution. As a result, the production yield of particles was not high to such an extent that it takes 90%. Moreover, particle growth would take place in the solution. Thus, the BET specific surface area of the particles for joining material thus obtained was small to such an extent that it takes 1.9 m²/g, the BET diameter was large to such an extent that it takes 353 nm, and the mass ratio of the organic protective film was low to such an extent that it takes 0.4% by mass. In addition, in the Time-Of-Flight Secondary Ion Mass Spectrometry, detected amounts of C₃H₃O₃⁻ ions and C₃H₄O₂⁻ ions were respectively large to such an extent that they indicate 0.21 times and 0.48 times the detected amount of Cu⁺ ions. Thus, the low temperature sinterability was poor, and the joining strengths were low to such an extent they respectively indicate 4 MPa and 8 MPa.

Since the reducing agent is added and mixed under alkaline condition of pH 10 in the comparative example 3, copper ions changed to the copper (II) hydroxide in the solution. As a result, the production yield of particles was not high to such an extent that it takes 80%. Moreover, particle growth would take place in the solution. As a result, the BET specific surface area of the particles for joining material thus obtained was small to such an extent that it takes 1.8 m²/g, the BET diameter was large to such an extent that it takes 373 nm, and the mass ratio of the organic protective film was low to such an extent that it takes 0.3% by mass. Further, in the time-of-flight secondary ion mass spectrometry, detected amounts of C₃H₃O₃⁻ ions and C₃H₄O₂⁻ ions were respectively large to such an extent that they indicate 0.30 times and 0.50 times the detected amount of Cu⁺ ions. In addition, the detected amount of ions of C₅ or more was large to such an extent that it indicates 0.010 times the detected amount of Cu⁺ ions. Thus, the low temperature sinterability was poor, and the joining strengths were low to such an extent that they respectively indicate 4 MPa and 8 MPa.

Since ammonium formate and formic acid are used as the reducing agent in the comparative examples 4 and 5, reduction of the copper citrate did not proceed so that target particles cannot be produced.

Since synthetic solution was heated only for one hour at 70° C. in the comparative example 6, reduction of copper citrate was not completed so that target particles cannot be produced.

Since the synthetic solution is heated for a long time such as three hours at 70° C. in the comparative example 7, reduction of the copper citrate too proceeded so that the particle growth would take place in the solution. As a result, the BET specific surface area of the particles for joining material thus obtained was small to such an extent that it takes 2.5 m²/g, the BET diameter was large to such an extent that it takes 268 nm, and the mass ratio of the organic protective film was low to such an extent that it takes 0.4% by mass. In the Time-Of-Flight Secondary Ion Mass Spectrometry, the detected amounts of C₃H₃O₃⁻ ions was small to such an extent that it indicates 0.04 times the detected amount of Cu⁺ ions. Thus, the low temperature sinterability was poor, and the joining strength was also low to such an extent that it indicates 10 MPa.

Since the synthetic solution is heated for 1.5 hours at a high temperature of 85° C. in the comparative example 8, reduction of the copper citrate too proceeded so that the particle growth would take place in the solution. As a result, the specific surface area of the particles for joining material thus obtained was small to such an extent that it takes 2.9 m²/g, and the BET diameter was large to such an extent that it takes 231 nm. In the Time-Of-Flight Secondary Ion Mass Spectrometry, detected amounts of C₃H₃O₃⁻ ions and C₃H₄O₂⁻ ions were respectively large to such an extent that they indicate 0.03 times and 0.04 times the detected amount of Cu⁺ ions. Thus, the low temperature sinterability was poor, and the joining strength was low to such an extent that it indicates 12 MPa.

Since the synthetic solution is heated for 2.5 hours at a low temperature of 55° C. in the comparative example 9, reduction of copper citrate was not completed so that target particles cannot be produced.

On the contrary, as apparent from the Tables 1 to 6a, 6b, since there is employed, in the examples 1 to 11, an approach to add and mix reducing agent under acidic condition where the pH is not less than 3 and is not more than 7 to use, as the reducing agent, hydrazine-hydrate and anhydrous hydrazine to set the maximum temperature at the time of heating of the synthetic solution to 60° C. or more and to 80° C. or less and to set its holding time to 1.5 hours or more and to 2.5 hours or less, the production yield of the particles for joining material was high to such an extent that it is not less than 90% and is not more than 97%, and the BET specific surface area was large to such an extent that it is not less than 3.5 m²/g and is not more than 7.5 m²/g. The BET diameter was small to such an extent that it is not less than 89 nm and is not more 192 nm. Moreover, the mass ratio of the organic protective film was not less than 0.5% by mass and is not more than 2.0% by mass so that the copper nanoparticles of base particles are completely coated. Further, in the Time-Of-Flight Secondary Ion Mass Spectrometry, detected amounts of C₃H₃O₃⁻ ions and C₃H₄O₂⁻ ions were respectively in a range of 0.05 times to 0.2 times the detected amount of Cu⁺ ions, and detected amount of ions of C₅ or more was less than 0.005 times the detected amount of Cu⁺ ions. Further, the decomposition amount ratio of the organic protective film was such that decomposition is made in a high ratio of 75% or more by mass to 88% or less by mass. As a result, the residue of the organic protective was less. In addition, gas components produced at the time of baking of particles for joining material were N₂, H₂O, CO₂ and C₃H₆O. From these facts, satisfactory joining strengths as the joined body, which are not less than 15 MPa and is not more than 52 MPa were obtained in the range where the joining temperature is not less than 200° C. and is not more than 300° C.

### INDUSTRIAL APPLICABILITY

The particles for joining material according to the present invention can be utilized as lead-free particles for joining for fine pitch, and paste for joining obtained with such particles for joining being as raw material can be used suitably for mounting fine electronic components.

1. Particles for joining material including an organic protective film formed on the surface of copper nanoparticles, characterized in
that the particles for joining material is such that the BET specific surface area is in a range of 3.5 m²/g to 8 m²/g, and the BET diameter converted from the specific surface area is in a range of 80 nm to 200 nm,
that the organic protective film is included in a range of 0.5% to 2.0% by mass with respect to 100% by mass of the particles for joining material, and
that when the particles for joining material are analyzed by using the Time-Of-Flight Secondary Ion Mass Spectrometry (TOF-SIMS), respective detected amounts of C₃H₃O₃⁻ ions and C₃H₄O₂⁻ ions are in a range of 0.05 times to 0.2 times a detected amount of the Cu⁺ ions, and a detected amount of ions of C₅ or more is in a range less than 0.005 times the detected amount of Cu⁺ ions.

2. Particles for joining material according to claim 1,
wherein when heated for 30 minutes at a temperature of 300° C. under an inert gas atmosphere, the organic protective film is decomposed not less than 50% by mass, and gas thus decomposed is vaporized gas and water vapor of carbon dioxide gas, nitrogen gas or acetone.

3. A paste for joining including a volatile solvent, and the particles for joining material according to claim 1.

4. A method comprising: adding a pH adjusting agent into an aqueous dispersion of copper citrate at a room temperature to make pH adjustment so that the pH is not less than 3 and is not more than 7; adding and mixing hydrazine compound into the pH adjusted aqueous dispersion of copper citrate under an inert gas atmosphere; heating the mixed solution thus obtained under the inert gas atmosphere so that the temperature is not less than 60° C. and is not more than 80° C.; and holding the heated mixed solution for a time period which is not less than 1.5 hours and is not more than 2.5 hours to thereby reduce the copper citrate to produce copper nanoparticles thus to produce particles for joining material including an organic protective film formed on the surface of the copper nanoparticles.

5. A method comprising: mixing a volatile solvent and the particles for joining material according to claim 1, or particles for joining material produced in accordance with a method to prepare a paste for joining, the method comprising: adding a pH adjusting agent into an aqueous dispersion of copper citrate at a room temperature to make pH adjustment so that the pH is not less than 3 and is not more than 7; adding and mixing hydrazine compound into the pH adjusted aqueous dispersion of copper citrate under an inert gas atmosphere; heating the mixed solution thus obtained under the inert gas atmosphere so that the temperature is not less than 60° C. and is not more than 80° C.; and holding the heated mixed solution for a time period which is not less than 1.5 hours and is not more than 2.5 hours to thereby reduce the copper citrate to produce copper nanoparticles thus to produce particles for joining material including an organic protective film formed on the surface of the copper nanoparticles.

6. A method of producing a joined body, which includes:
a step of applying or coating, onto the surface of a substrate or an electronic component, the paste for joining according to claim 3 or the paste for joining, which has been prepared to form a coated layer by a method comprising: adding a pH adjusting agent into an aqueous dispersion of copper citrate at a room temperature to make pH adjustment so that the pH is not less than 3 and is not more than 7; adding and mixing hydrazine compound into the pH adjusted aqueous dispersion of copper citrate under an inert gas atmosphere; heating the mixed solution thus obtained under the inert gas atmosphere so that the temperature is not less than 60° C. and is not more than 80° C.; and holding the heated mixed solution for a time period which is not less than 1.5 hours and is not more than 2.5 hours to thereby reduce the copper citrate to produce copper nanoparticles thus to produce particles for joining material including an organic protective film formed on the surface of the copper nanoparticles;
a step of overlapping the substrate and the electronic component with each other through the coated layer; and
a step of heating, at a temperature which is not less than 200° C. and is not more than 300° C., under an inert atmosphere while applying a pressure of 30 MPa or less,
the substrate and the electronic component which have been overlapped with each other to sinter the coated layer to thereby form a joining layer thus to join the substrate and the electronic component by the joining layer.

7. A paste for joining including a volatile solvent, and the particles for joining material according to claim 2.

8. A method comprising: mixing a volatile solvent and the particles for joining material according to claim 2, or particles for joining material produced in accordance with a method to prepare a paste for joining, the method comprising: adding a pH adjusting agent into an aqueous dispersion of copper citrate at a room temperature to make pH adjustment so that the pH is not less than 3 and is not more than 7; adding and mixing hydrazine compound into the pH adjusted aqueous dispersion of copper citrate under an inert gas atmosphere; heating the mixed solution thus obtained under the inert gas atmosphere so that the temperature is not less than 60° C. and is not more than 80° C.; and holding the heated mixed solution for a time period which is not less than 1.5 hours and is not more than 2.5 hours to thereby reduce the copper citrate to produce copper nanoparticles thus to produce particles for joining material including an organic protective film formed on the surface of the copper nanoparticles.

9. A method of producing a joined body, which includes:
a step of applying or coating, onto the surface of a substrate or an electronic component, the paste for joining according to claim 7 or the paste for joining, which has been prepared to form a coated layer by a method comprising: adding a pH adjusting agent into an aqueous dispersion of copper citrate at a room temperature to make pH adjustment so that the pH is not less than 3 and is not more than 7; adding and mixing hydrazine compound into the pH adjusted aqueous dispersion of copper citrate under an inert gas atmosphere; heating the mixed solution thus obtained under the inert gas atmosphere so that the temperature is not less than 60° C. and is not more than 80° C.; and holding the heated mixed solution for a time period which is not less than 1.5 hours and is not more than 2.5 hours to thereby reduce the copper citrate to produce copper nanoparticles thus to produce particles for joining material including an organic protective film formed on the surface of the copper nanoparticles;
a step of overlapping the substrate and the electronic component with each other through the coated layer; and
a step of heating, at a temperature which is not less than 200° C. and is not more than 300° C., under an inert atmosphere while applying a pressure of 30 MPa or less,
the substrate and the electronic component which have been overlapped with each other to sinter the coated layer to thereby form a joining layer thus to join the substrate and the electronic component by the joining layer.
